(19) United States
(12) Patent Application Publication
(10) Pub. No.: US 2017/0279281 A1
(43) Pub. Date: Sep. 28, 2017

(54) POWER GENERATION ASSEMBLY, MANAGEMENT SYSTEM AND METHOD

(71) Applicant: COMGEN POWER SOLUTIONS LTD., Red Deer County (CA)

(72) Inventors: Marty J. HAMM, CARSTAIRS (CA); Ronald J. GRAW, CALGARY (CA)

(21) Appl. No.: 15/467,989

(22) Filed: Mar. 23, 2017

Related U.S. Application Data
(60) Provisional application No. 62/312,150, filed on Mar. 23, 2016.

(51) Int. Cl. H02J 3/46

(52) U.S. Cl. CPC H02J 3/46

(57) ABSTRACT

There is described a method and a kit for implementing the method for managing a power distribution system. The method comprises providing a renewable power source and a natural gas power plant in a microgrid having an electrical infrastructure sized for a maximum output power. The method further comprises monitoring the renewable output power of the renewable power plant, and controlling an output power of the natural gas power plant to produce a natural gas output power that is combined to the renewable output power to constantly output the maximum output power of the electrical infrastructure capacity into the microgrid, without using any battery or condenser as a buffer to react to required changes due to the variable and independent output from the renewable power source.

### BACKGROUND

### (a) Field

The subject matter disclosed generally relates to power management and more particularly to effective power management in systems incorporating multiple power sources.

### (b) Related Prior Art

In the field of energy management, use of fossil fuels takes part both in the problem and the solution. While we wait for technology that will change the course our species energy use, we must first immediately face the issues of energy management and bridge the gap with novel ways to use available technology. In order to obtain the desired result, the collaboration of environmental groups and the energy industry is of the utmost importance in order to facilitate real change in the immediate future.

The costs for the installation of wind and solar power centrals are high. They require an electrical infrastructure having the capacity for 100% of the available/maximum potential wind or solar generator output.

The unavoidable condition with wind and solar energy is that Mother Nature does not constantly provide the optimum conditions so as to be able to constantly generate energy at the utmost efficiency and desired output. It therefore exposes some of the inefficiencies or weaknesses of renewable resources. In fact, the amount of actual power produced from wind power accounts for less than 30% of its available and rated capacity.

FIG. 1, published as WO2011074009 by Hanson, schematically illustrates an existing power management system according to conventional art. In the given figure, block 101 refers to a solar power source and block 102 refers to an AC/DC power source which is sourced from the electrical grid; i.e., a utility grid power source. The output power generated by the solar power source 101 and the electrical grid AC/DC power source 102 are combined to feed a required load 103. A charge controller (or a battery) 104 accepts output power generated by solar and electrical grid AC/DC power sources 101, 102. A current sensor 105 measures the output current of the AC/DC power source 102.

In conclusion, none of the existing solutions safely utilize the full capacity of the electrical utility or load which is sized based on the maximum (or desired) power output of the primary renewable power source, with the preferred power contribution being the primary power source and the complimentary secondary power source being a natural gas power source that is not fed by the power grid.

Accordingly, new technology is needed to respond to these technological drawbacks.

### SUMMARY

According to an aspect of the invention, there is provided a method for managing a power distribution system. The method comprises:
providing a renewable power source and a natural gas power plant connected to an electrical infrastructure being sized for a maximum output power;
monitoring a renewable output power of the renewable power source;
controlling an output power of the natural gas power plant based on the monitored renewable output power to produce a natural gas output power that is combined to the renewable output power to constantly output the maximum output power into the electrical infrastructure.

According to an embodiment, there is further provided monitoring a load output power.

According to an embodiment, there is further provided, using a device for controlling the output power of the natural gas power plant, constantly comparing the load output power and the maximum output power.

According to an embodiment, the device for controlling the output power of the natural gas power plant is the only device for controlling a power and is not used to control the renewable output power of the renewable power source.

According to an embodiment, there is further provided monitoring the natural gas output power.

According to an embodiment, the monitoring of the renewable output power, of the natural gas output power and of the load output power is performed using a voltage sensor and a current sensor for each monitoring.

According to an embodiment, the controlling is performed without using any battery as a buffer.

According to another aspect of the invention, there is provided a kit for managing a power system. The kit comprises:
a primary power source sensor to be connected at an output of a renewable power source of the power system to monitor a renewable output power;
a load sensor to be connected at an output of the power system to monitor a power system output power;
a load sharing device to combine, into a total output power, the renewable output power and a natural gas plant output power from a natural gas power plant of the power system into an electrical infrastructure having a maximum power output;
a controller to be connected on an output of the natural gas power plant and to control the natural gas plant output power therefrom, the controller:
being operably connected to the primary power source sensor and the load sensor;
having a processor to determine, based on the monitored renewable output power, a natural gas output power required to get the maximum power output in the load sharing device; and
having connections to the output of the natural gas power plant to ensure the load sharing device constantly provides the total output power substantially equal to the maximum power output of the electrical infrastructure.

According to an embodiment, there is further provided a secondary power source sensor to be connected at an output of the natural gas power plant to monitor the natural gas plant output power.

According to an embodiment, each of the primary power source sensor, the secondary power source sensor and the load sensor comprises a current sensor and a voltage sensor.

According to an embodiment, the load sharing device is to be connected between the renewable power source and the electrical infrastructure, and between the natural gas power plant and the electrical infrastructure, to prevent the electrical infrastructure from any direct connection with the renewable power source and with the natural gas power plant.

According to another aspect of the invention, there is provided a power management system comprising:
a renewable-type primary power source generating a primary power output;
a controllable secondary power source controllably generating a secondary power output, the controllable secondary power source not being fed by an electrical grid;
a power monitoring sensor connected to and constantly monitoring the primary power output and to the secondary power output; and
a power sharing control mechanism, with no connection to an energy-storing buffer, that:
operatively combines the primary power output and the secondary power output into a constant combined power output to an electrical infrastructure having a maximum power capacity, and
controls, based on the monitored primary power output and to the secondary power output, the controllable secondary power source such as the constant combined power output is composed of a maximum available primary power output and a minimum complementary secondary power output and is substantially constantly equal to the maximum power capacity.

According to an embodiment, the power management system provides the constant combined power output constantly equal to the maximum power capacity without using any one of a battery and a condenser.

According to an embodiment, the controllable secondary power source is a natural gas power plant.

### BRIEF DESCRIPTION OF THE DRAWINGS

Further features and advantages of the present disclosure will become apparent from the following detailed description, taken in combination with the appended drawings, in which:

FIG. 1 is a schematic of a power management system in accordance with existing prior art;

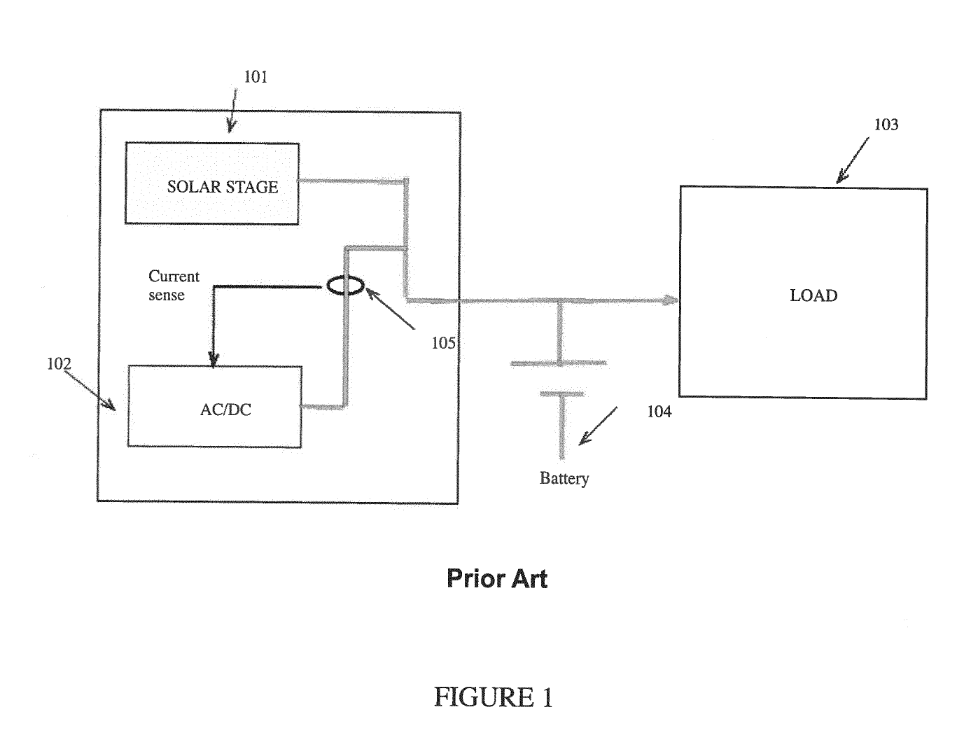

FIG. 2 is a schematic of the power management system in accordance with a first embodiment;

FIG. 3 is a schematic of the power management system in accordance with a second embodiment;

FIG. 4 is a schematic of the power management system in accordance with a third embodiment;

FIG. 5 is a schematic of the power management system in accordance with a fourth embodiment; and

FIG. 6 is a flow chart illustrating steps performed in accordance with embodiments.

It will be noted that throughout the appended drawings, like features are identified by like reference numerals.

### DETAILED DESCRIPTION

Exemplary embodiments now will be described with reference to the accompanying drawings. The disclosure may, however, be embodied in many different forms and should not be construed as limited to the embodiments set forth herein. Rather, these embodiments are provided so that this disclosure will be thorough and complete and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or combinations thereof. It will be understood that when an element is referred to as being “connected” or “coupled” to another element, it can be directly connected to, or coupled to the depicted element through intervening additional elements. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to provide clear and concise teaching, a glossary of central terms or expressions is herein provided.

Primary power source or plant refers to a main power source used to produce a base power output which is independent from the secondary power source, and preferably refers to a renewable power source. A plurality of such primary power sources can be provided.

Secondary power source refers to one or more complementary power sources in the context of a power generation arrangement including multiple power sources. Secondary power source preferably refers to a power source that is not fed by an electric grid (i.e., power from the electric grid) and refers in an embodiment to a natural gas power plant, i.e., a turbine fueled by natural gas and driving an electric generator. Moreover, the natural gas power plant may be supplemented with a generator that is powered indirectly off of the waste heat from the natural gas generator. Accordingly, the preferred secondary power source is designed and sized to compensate up to 100% of the primary power source (when not available) and consists of an AC power source that is not fed by the grid (electric current distribution grid).

Electrical Utility or Load refers to an electrical utility, load capacity or defined need in electrical power that defines the required output of the power generation arrangement. When the load is an electrical utility, including an entry point to the grid where electric power is sold, it is typically designed based on the maximum power output capability of the primary power source and at the point of supply of the primary power source. For existing wind and solar farms (or other types of renewable power plants), an electrical infrastructure, including cabling and all electric devices, is built to have the capacity for 100% of the available/maximum potential renewable power plant output. This electrical infrastructure is the load to which electric power is fed. For new wind or solar farms, this load or infrastructure may be built with more capacity than the 100% renewable power generation as it may be decided to factor in 100% renewable power and additional capacity from a natural gas power source. Also, as noted above, the load may be fed from multiple primary power sources (e.g., wind turbines, hydro turbines, solar farms) and the combined power feeds into that larger load/infrastructure.

It has to be noted that the figures schematically depict simplified structure only showing some elements and functional entities; all the depicted elements being logical units whose implementation may differ from what is shown. The shown connections are logical connections; the actual physical connections may differ. It must be apparent to a person skilled in the art that the depicted structure may also comprise additional functions and structures. It should be appreciated that these functions, structures and elements, as the protocols involved in communications, are non limitative and are intended for teaching of the embodiment in accordance with the present disclosure.

Similarly, all logical units described and depicted in the figures are intended to include the required hardware and/or software components required to perform the intended function. Therefore, each unit may comprise within itself one or more components which are implicitly understood as to perform the intended function and for maintenance. According to the needs, these components may be operatively or communicatively coupled to each other.

Supplementing renewable energy with natural gas powered generation is an economical solution that can increase utilization of an already installed infrastructure and result in further reductions in emission of greenhouse gases (GHG) when coal fired power is displaced. The goal of the present solution is not to remove renewable energy from the solution but to enhance a model of development that maximizes infrastructure capacity and uptime. Therefore, the solution provides an immediate impact as on generation of greenhouse gases (GHG) as a new structure for future development.

Furthermore, in other existing multiple power source systems, there is no solution for combining controllable secondary natural gas power sources with primary renewable power sources while being able to ensure a power output that is both substantially constant and maximized with respect to the electrical infrastructure that serves the power source systems, which is sized for the primary renewable power source running at full capacity.

Accordingly, the present solution involves installing a compact and efficient natural gas generator in combination with the renewable power source, which includes wind turbines, hydro turbines, and solar power generators from all types, or any other source, with the natural gas generator being capable of generating up to 100% of the maximum capacity of the renewable power plant, in order to respond to moments or periods when the renewable source of energy (e.g., wind, sun, water stream, etc.) is not sufficient to generate the desired output (in other words 70% of the time). The result is a significant improvement in the utilization of existing facilities and a reduction in greenhouse gases (GHG) by reducing power generated with coal, and ultimately eliminating use of coal-based generated power.

According to another embodiment not shown in the figures, a single secondary power source is installed and used in conjunction with more than one primary power sources. According to such an embodiment, the secondary power source is sized to handle up to the combined power of primary power sources and provide the constant and maximum power output to the grid, shown as the electric utility for which a constant output, maximizing the power for which the electrical infrastructure is sized, is desired.

The present power management system further permits, using sensors on the power sources (especially on the renewable power source) and a controller acting on the output of the natural gas power plant, balancing and controlling the use of power produced from the natural gas power plant to complement the power from the renewable power source at all times, thereby producing a constant power output to be fed to the grid while maximizing the power for which the electrical infrastructure connecting to the grid is sized. When the primary renewable power source produces less power, the controller acts on the natural gas power plant to increase, stabilize, or decrease the power produced to account for primary renewable power source decreasing or being unavailable. Natural gas power plants can respond to these fast-changing requirements.

The solution combines diverse existing (i.e., already built) power plants of all types and sizes (normally one or more renewable power generators with a natural gas power generator, and with a new (i.e., not previously installed) power management system designed to optimize the available and existing infrastructure. Therefore, the power management system can be paired with all conventional forms of engine-driven power generators and with wind turbines, solar farms or hydroelectric power sources to produce similar results. The power management system may further include wireless communication capabilities that may facilitate communications regarding the energy supply and demand, thus stimulating synergy between the energy provider and the energy consumer(s).

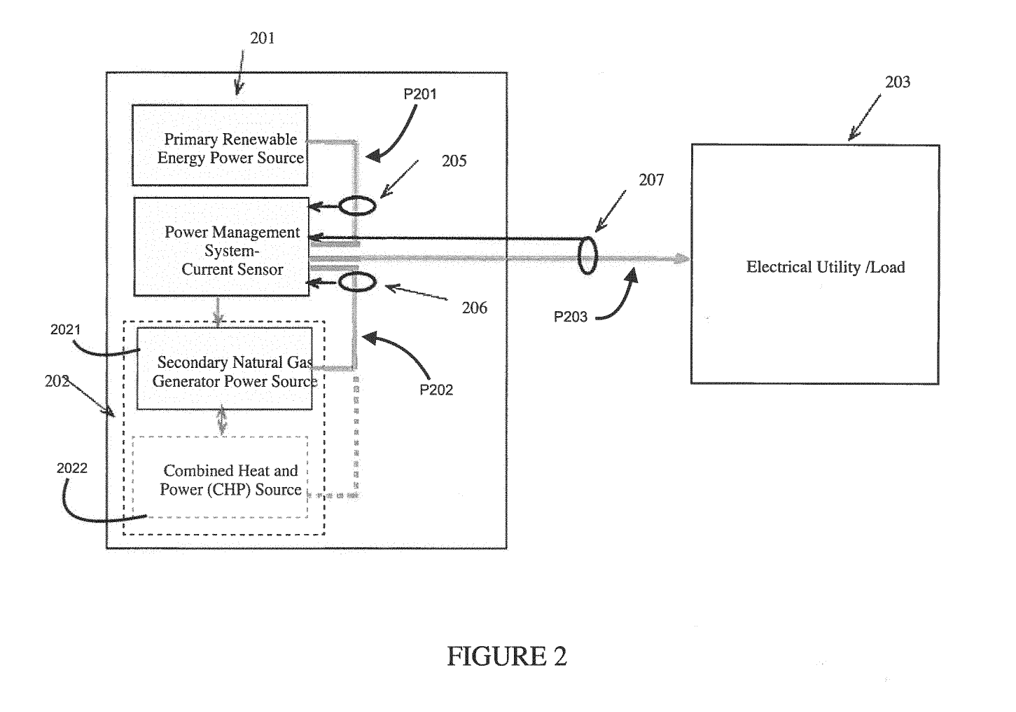

Referring now to the drawings, and more particularly to FIG. 2, a block diagram shows the power management system according to a first embodiment. On FIG. 2 there is illustrated a renewable energy primary power source 201 (i.e., a wind turbine, solar panels, or hydroelectric power source) and a controllable secondary power source 202. As illustrated, the controllable secondary power source 202 is a power source that comprises a natural gas generator power source 2021 supplemented by a generator, a combined heat and power (CHP) source 2022, that utilizes waste heat from the natural gas generator 2021. Power output P201 generated by the primary power source 201 and power output P202 generated by the secondary power source 202 are combined together as a power input P203 designed to feed a load 203, where the load can be the grid to which the power is fed. The power input P203 is designed to supply a constant power output that safely utilizes (i.e., maximizes) the full capacity of the existing electrical infrastructure to the grid or load, the electrical infrastructure being sized based on the maximum power output of the primary power source 201. A primary current load sensor 205 is provided to measure the power output P201 of the primary power source 201. The data collected by the primary current load sensor 205 is used to regulate the secondary power source 202 such that the secondary power source 202 will compensate for power not provided by the primary power source 201.

Furthermore, according to an embodiment, a secondary load current sensor 206 measures the current of the secondary power output P202 generated by the secondary power source 202, with the data collected being used to regulate the secondary power source 202. Accordingly, the secondary power source 202 is regulated independently while taking into account to the power output P201 generated by the renewable primary power source 201.

Furthermore, an input load current sensor 207 is provided to measure the combined power outputs P201, P202 from the primary power source 201 and secondary power source 202 (i.e., power input P203 discussed above. The measurements collected by the input load current sensor 207 are used to regulate the secondary power output P202 of the secondary source 202 so as to prevent the power input P203, sum of the power outputs P201 and P202, to overload of the load 203, which can be, for example, the electrical infrastructure to the grid where the produced power is sold.

It will be apparent to those of ordinary skill in this art that the concept is not limited to two input power sources and can be extended to several input power sources, with these power sources including at least one primary power source.

According to the described embodiment, the power input P203 is the sum of power outputs P201, P202 and results from a current sharing control mechanism involving the current originating from the secondary power source 202 (i.e. natural gas power plant 2021) regulated to the desired level, namely the minimum level required to compensate from lack of primary power output P201, while the renewable energy primary power source 201 delivers the maximum amount of power P201 available at every given instant, this power being variable. The maximum amount of available power P201 may be the entire power output P201 generated by the renewable energy primary power source 201. It may also refer to a lesser value, when, for instance, no more than the available power output P201 is required by the load 203. However, if the load 203 is the electrical infrastructure to the grid, then the power management system will seek to maximize at all times the power input P203 entering the electrical infrastructure to the grid to the point where P203 is constant and maximized with respect to how much the electrical infrastructure is sized in terms of electric power or current and the maximum output capacity of the primary power source 201.

Moreover, due to detection of a signal indicative of current from another power source (not illustrated), the secondary power source 202 may not merely maintain itself at a well-defined maximum output current limit, but may reduce the aforementioned limit so that the sum of power outputs P201 and P202 from the renewable energy primary power source 201 and the secondary power source 202, specifically the output power (or the input power P203 from the load perspective), stays constant and still provides maximum power output to load 203 as defined by the power output P201 of the primary power source 201.

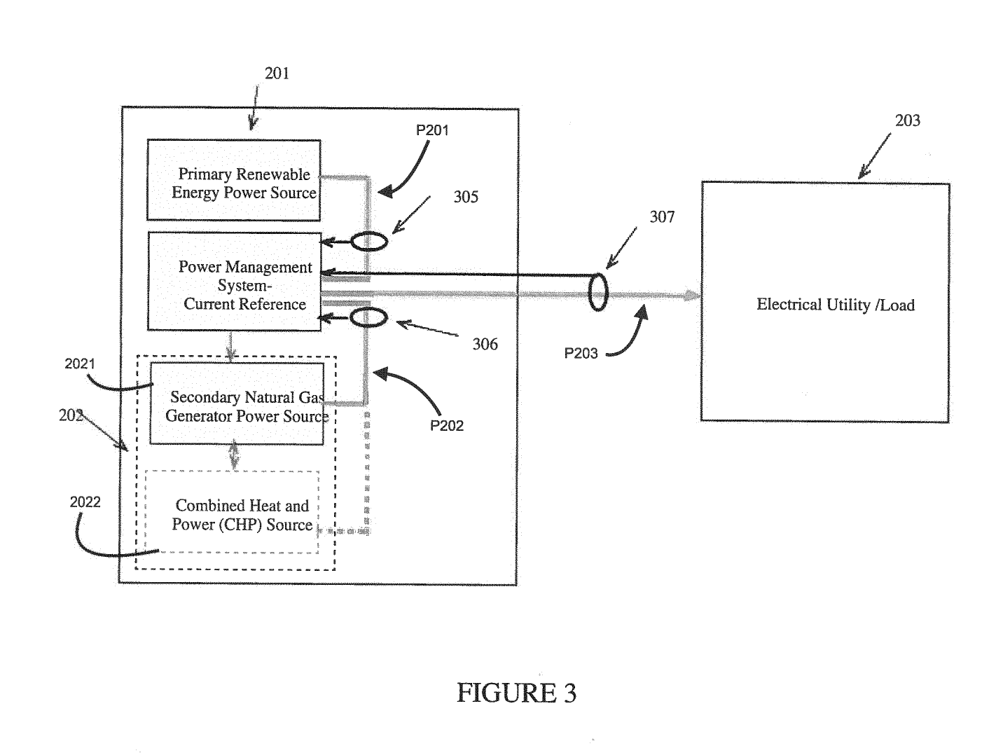

FIG. 3 illustrates a second embodiment. A renewable energy primary power source 201 and a controllable secondary power source 202 are schematically illustrated. Power output P201 generated by the renewable energy power source 201 and power output P202 generated by the secondary power source 202 are combined in a power input P203 to feed a load 203. A primary load current sensor 305 is connected to one or more current reference inputs of the primary power source 201 and accordingly measures one or more primary current reference signals, with the data collected being used to determine how much power output P202 has to be generated by the secondary power source 202. A secondary load sensor 306 is connected to one or more current reference inputs of the controllable secondary power source 202. The secondary current sensor 306 measures one or more secondary current reference signals, with the data collected being used to determine and control the secondary power source 202 accordingly. The power output P202 generated by the secondary power source 202 is thereby modified in response to the increase or decrease of the power output P201 generated by the renewable primary power source 201. Thus, this functional scheme provides the true value of current reference signals and increasing the reliability of the system.

A load current sensor 307 is connected to one or more current reference inputs to measure the combined power input summing up the primary power output P201 from the primary power source 201 and the secondary power output P202 from the secondary source 202 and accordingly is able to sense the one or more current reference signals, with the data collected being processed by the power management system which regulates the power output P202 to be generated by the secondary power source 202 as to prevent overload of the load 203 by having the power input P203 exceeding a maximum load capacity.

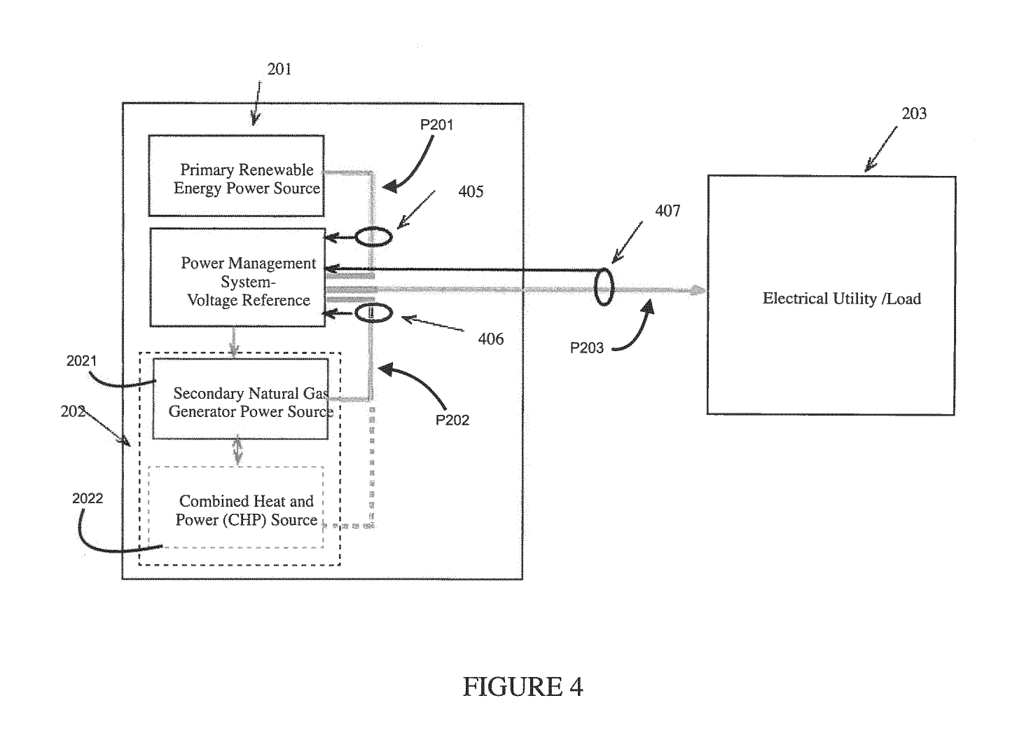

FIG. 4 illustrates a third embodiment. A renewable energy primary power source 201 and a controllable secondary power source 202 are illustrated. A primary power output P201 generated by the renewable energy primary power source 201 and secondary power output P202 generated by the natural gas generator power source 202 are combined as a load power input designed to feed a load 203. A primary load current sensor 405 is connected to one or more voltage reference inputs of the primary power source 201 and accordingly senses one or more voltage reference signals, with the data collected being processed by the power management system accordingly which regulates the secondary power output P202 of the secondary power source 202 accordingly. A secondary load current sensor 406 is connected to one or more voltage reference inputs of the controllable secondary power source 202. The secondary current sensor senses one or more voltage reference signals, with the data collected being processed by the power management system accordingly, which controls the secondary power source 202 accordingly. The voltage reference for the controllable secondary power source is reduced such that the generation of both the voltage and the current generated by the secondary power source 202 reduces when current of the renewable primary power source increases. This functional scheme features an active load sharing mechanism during the entire operating range from an idle condition to maximum power generation condition. Thus, this functional scheme provides the true value of the voltage reference signal thus increasing the reliability of power management system.

Furthermore, a load sensor 407 is connected to one or more voltage reference inputs to measure the combined voltage from the primary power source 201 and secondary power source 202 (a.k.a. the voltage of the load power input P203) and accordingly senses the voltage reference signal and regulates the power output P202 of the secondary power source 202 so as to prevent overload of the load 203 by having the power input P203 exceeding a maximum load capacity.

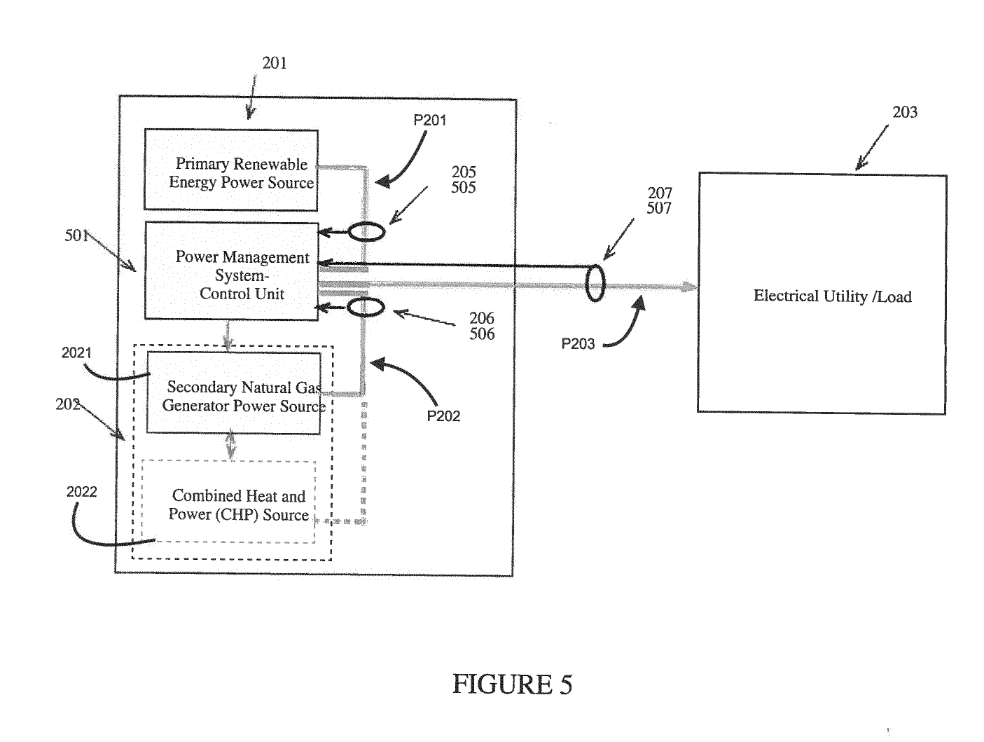

FIG. 5 illustrates the power management system according to a fourth embodiment. A control unit 501 is provided to control the controllable secondary power source 202 based on the feedbacks provided by a primary source voltage sensor 205 and current sensor 505, and the secondary source voltage sensor 206 and current sensor 506, to which the control unit 501 is operably connected. Based upon the feedback provided by the primary current sensor 505 and the secondary source current sensor 506, the control unit 501 controls the controllable secondary power source 202 and adjusts the overall current such that sum of power outputs P201, P202 provided by both primary and secondary power sources 201, 202 provides a constant and maximum output.

Furthermore, a load voltage sensor 207 and a load current sensor 507, to which the control unit 501 is operably connected, are provided to measure the combined power from the primary power source 201 and the controllable secondary power source 202 and accordingly regulate the output of the secondary source 202 so as to prevent overload of the load 203. Thus, effective power management and overall reliability of the whole system is ensured.

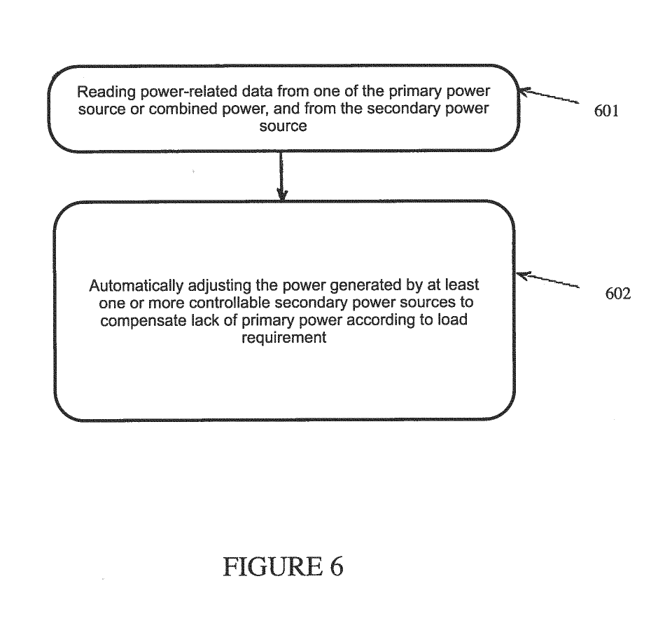

A method of operation of a power management system involving multiple power sources among at least one primary power source being of the type of a renewable energy source, and a controllable secondary power source that is not fed by the electrical grid is illustrated through FIG. 6. The method is illustrated as a collection of blocks in a logical flow graph, which presents a sequence of operations that require a hardware computing environment on which the method is implemented. The order in which the process is described is not intended to be construed as a limitation.

At step 601, power-related data read from at least one of the following components are collected. These components are a) the primary power output P201 generated by the primary power source 201, and b) the load input power P203. Additionally, and optionally, controllable power-related data read from the secondary power output P202 generated by the controllable secondary power source 202 is collected. The read data resulting from the combination of the primary power output P201 and the secondary power output P202 are designed to be fed to the load 203.

In the present context, power-related data read from the above components is intended to include directly read current, directly read voltage, reading of reference current, reading of reference voltage or any combination thereof.

At step 602, the method further comprises adjusting the power generated by the secondary power source 202 according to read power-related data, namely comparison between controllable power-related data and other power-related data, so as to constantly obtain the desired and preferably maximum (with respect to the sizing of the electrical infrastructure) load input power P203. This adjustment is performed by providing the controller 501 acting on the power output connections of the secondary power plant 202. It means that the controller 501 is operably connected to the output of the gas power plant and acts as a “valve” that lets a specific power output being fed into the power management system.

Since natural gas power plants have a very high reactivity to these changes (i.e., the rate of natural gas admitted to the combustor), the change in the requirement for electric power generation happens at a sufficiently high rate to respond to changes in the primary output power P201 and thereby level the total output power P203 to the constant and maximized output power. By operably connecting the controller 501 directly to the output of the natural gas power plant, there is no need for a battery, condenser or the like in the power management system to act as a buffer and such parts can be avoided, thereby making the power management system simpler, with lower risks of failure.

Accordingly, steps 601 and 602 are intended to be performed automatically, continuously, or performed at very close time intervals (which are preferably less than a few seconds (e.g., <10 s), or more preferably less than 1 second or even less, such as a few tenths of seconds, for better reactivity), such that the system is able to automatically (i.e., without human intervention) and instantaneously (i.e., in real-time) react to any increase or decrease of the power output P201 generated by the primary power plant 201 and thereby provides stable maximum, or desired level of, power input P203 to the load 203 while preventing any power overload to be transmitted to the load 203 without the necessity of feeding the secondary power plant 202 using the electrical grid.

Furthermore, the method is intended to be embodied in hardware components running software. When programmed in relation with hardware components, the software responsible to the realization of the method may also be stored on a non-transitory data storage medium to further be loading in another hardware component for operation.

Accordingly, embodiments of the power management system and method of operation of the power management system as disclosed in the present disclosure provide an efficient power control and sharing mechanism. It is useful for obtaining a balanced control of power produced from a preferred, primary and renewable power source and a controllable secondary power source which is not fed by the grid such that the combined power sources supply a constant and maximum output (or other desired constant output) that safely utilizes the full capacity of the electrical utility or load in a manner that maximize power contribution of the primary power source without the necessity to feed the secondary power source using the electric grid. Supplementing renewable energy with power generated using natural gas is an economically and beneficial solution that may maximize the utilization of already existing infrastructures while having the advantages of potentially reducing emission of greenhouse gases (GHG).

### Power Management System Controller 501

The power management system control unit or controller 501 is connected to the Primary Renewable Energy Power Source 201 through a current sensing device 205 and a voltage sensing device 505. The peak power capacity P201 of 201 represents the maximum system power capacity that is delivered to 203 from the combination of 201 and 202 (P203).

The power management system controller 501 is connected to the Secondary Natural Gas Generator Power Source 202 through a current sensing device 206 and a voltage sensing device 506. The maximum power capacity P202 of 202 is equal to the maximum power capacity of 201.

The power management system controller 501 is connected to the Electrical Utility 203 through a current sensing device 207 and a voltage sensing device 507. The capacity for load acceptance of 203 from 201 and 202 is greater than or equal to the maximum system power capacity of 201.

The power management system controller 501 is connected to the power output P201 and P202 from sources 201 and 202. The conditioning of power sources 201 and 202 prior to entry through P203 at the utility/load 203 occurs in the power management system 500.

The power management system controller 501 is thus on communication with the sensors (205, 206, 207, 505, 506, 507) from which it receives data. The data is then used by a processor of the power management system controller 501 which can perform various determinations as listed below. Based on these determinations performed by the processor, the processor can generate instructions to directly control, by the power management system controller 501, the output power of the natural gas power plant.

The following lists exemplify the actions performed in relation with the power management system controller 501 with regard to various events taking place.

Regarding the starting of source 201:
Power source 201 is energized
AC current and voltage from primary power source 201 is synchronized with the load 203
AC current and voltage from the primary power source 201 are measured at 205 and 505
   Current is limited to the capacity of the primary power source 201
   Voltage is limited to the rated voltage of the primary power source 201 and the transformer capacity
AC current and voltage P201 from the primary power source 201 are delivered to the load 203

Regarding the starting of secondary power source 202:
Secondary power source 202 is energized
AC current and voltage from the secondary power source 202 are synchronized with the load 203
AC current and voltage from the secondary power source 202 are measured at the sensing devices 206 and 506
   Current is limited to the capacity of primary power source 201
   Voltage is limited to the rated voltage of the secondary power source 202 and the transformer capacity
AC current and voltage P202 from the secondary power source 202 are delivered on to the load 203

By receiving power from both sources and outputting a combined power output, the power management system controller 501 acts as a load sharing (or power sharing) device or control mechanism. Regarding this load share, AC current and voltage from the primary power source 201 are measured at the sensing devices 205 and 505.
If AC current at the load 203 are lower than the maximum capacity of the primary power source 201:
   AC current and voltage from the primary power source 201 and the secondary power source 202 are measured at the sensing devices 207 and 507
   The power management system controller 501 reads data 601 and calculates reaction 602
   The power management system controller 501 increases the AC current output P202 from the secondary power source 202
      AC current and voltage from 202 are measured at the sensing devices 206 and 506
   The power management system controller 501 measures the AC current and voltage at the sensing devices 207 and 507
      The AC power sum of P203 at the load 203 is limited to the maximum capacity of the primary power source 201
If AC current and voltage at the load 203 are equal to the maximum capacity of the primary power source 201:
   AC current and voltage from the primary power source 201 and the secondary power source 202 are measured at the sensing devices 207 and 507
   The power management system controller 501 reads data 601 and calculates reaction 602
   The power management system controller 501 does not adjust the AC current output P202 from the secondary power source 202
      AC current and voltage from the secondary power source 202 are measured at the sensing devices 206 and 506
   The power management system controller 501 measures the AC current and voltage at the sensing devices 207 and 507
      The AC power sum of P203 at 203 is limited to the maximum capacity of the primary power source 201
If AC current and voltage are above the maximum capacity of the primary power source 201:
   AC current and voltage from the primary power source 201 and the secondary power source 202 are measured at the sensing devices 207 and 507
   The power management system controller 501 one reads data 601 and calculates reaction 602
   The power management system controller 501 decreases the AC current output P202 from the secondary power source 202
      AC current and voltage from the secondary power source 202 are measured at the sensing devices 206 and 506
   The power management system controller 501 measures the AC current and voltage at 207 and 507
      The AC power sum of P203 at 203 is limited to the maximum capacity of the primary power source 201

Regarding safety considerations:
Voltage limiting
   The AC voltage from the primary power source 201 is limited to the maximum capacity of the primary power source 201 and the load 203
      Controller 501 reads data from the sensing devices 505 and 507
         Alarm
         Shutdown
   The AC voltage from the secondary power source 202 is limited to the maximum capacity of the secondary power source 202 and the load 203
      Controller 501 reads data from 506 and 507
         Alarm
         Shutdown
Current limiting
   The AC current from the primary power source 201 is limited to the maximum capacity of the primary power source 201
      The power management system controller 501 reads data from the sensing devices 205 and 207
         Alarm
         Shutdown
   The AC current from the secondary power source 202 is limited to the maximum capacity of the primary power source 201
      The power management system controller 501 reads data from the sensing devices 206 and 207
         Alarm
         Shutdown

Example: For an individual wind turbine that is rated to produce 1.5 megawatts, a natural gas powered generator is installed at the base of the wind turbine and is supplemented with a generator powered off of the waste heat from the natural gas generator. The natural gas generator is sized to equal the output of the wind turbine (1.5 megawatts) in case the latter is incapable of producing maximum electric power at all times. The wind power is always the preferred and is primary source of power. The natural gas generator provides the difference so that the combined loads from the two sources produces the full 1.5 megawatts to the electrical utility grid. In an example, if the wind turbine is generating 0.60 megawatts of power, the natural gas generator is going to produce 0.90 megawatts of power output. A constant 1.5 MW of generated power is therefore going into the grid, thereby maximizing both the electrical infrastructure built for the renewable power plant and the electric power sold to the utility company operating the grid to which the power output is fed, and without requiring a battery or a condenser (or any energy-storing buffer) to act as a buffer to respond to the required changes.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for managing a power distribution system comprising:
providing a renewable power source and a natural gas power plant connected to an electrical infrastructure being sized for a maximum output power;
monitoring a renewable output power of the renewable power source;
controlling an output power of the natural gas power plant based on the monitored renewable output power to produce a natural gas output power that is combined to the renewable output power to constantly output the maximum output power into the electrical infrastructure.

2. The method of claim 1, further comprising monitoring a load output power.

3. The method of claim 2, further comprising, using a device for controlling the output power of the natural gas power plant, constantly comparing the load output power and the maximum output power.

4. The method of claim 3, wherein the device for controlling the output power of the natural gas power plant is the only device for controlling a power and is not used to control the renewable output power of the renewable power source.

5. The method of claim 2, further comprising monitoring the natural gas output power.

6. The method of claim 5, wherein the monitoring of the renewable output power, of the natural gas output power and of the load output power is performed using a voltage sensor and a current sensor for each monitoring.

7. The method of claim 1, wherein the controlling is performed without using any battery as a buffer.

8. A kit for managing a power system comprising:
a primary power source sensor to be connected at an output of a renewable power source of the power system to monitor a renewable output power;
a load sensor to be connected at an output of the power system to monitor a power system output power;
a load sharing device to combine, into a total output power, the renewable output power and a natural gas plant output power from a natural gas power plant of the power system into an electrical infrastructure having a maximum power output;
a controller to be connected on an output of the natural gas power plant and to control the natural gas plant output power therefrom, the controller:
being operably connected to the primary power source sensor and the load sensor;
having a processor to determine, based on the monitored renewable output power, a natural gas output power required to get the maximum power output in the load sharing device; and
having connections to the output of the natural gas power plant to ensure the load sharing device constantly provides the total output power substantially equal to the maximum power output of the electrical infrastructure.

9. The kit of claim 8, further comprising a secondary power source sensor to be connected at an output of the natural gas power plant to monitor the natural gas plant output power.

10. The kit of claim 9, wherein each of the primary power source sensor, the secondary power source sensor and the load sensor comprises a current sensor and a voltage sensor.

11. The kit of claim 8, wherein the load sharing device is to be connected between the renewable power source and the electrical infrastructure, and between the natural gas power plant and the electrical infrastructure, to prevent the electrical infrastructure from any direct connection with the renewable power source and with the natural gas power plant.

12. A power management system comprising:
a renewable-type primary power source generating a primary power output;
a controllable secondary power source controllably generating a secondary power output, the controllable secondary power source not being fed by an electrical grid;
a power monitoring sensor connected to and constantly monitoring the primary power output and to the secondary power output; and
a power sharing control mechanism, with no connection to an energy-storing buffer, that:
operatively combines the primary power output and the secondary power output into a constant combined power output to an electrical infrastructure having a maximum power capacity, and
controls, based on the monitored primary power output and to the secondary power output, the controllable secondary power source such as the constant combined power output is composed of a maximum available primary power output and a minimum complementary secondary power output and is substantially constantly equal to the maximum power capacity.

13. The power management system of claim 12, wherein the power management system provides the constant combined power output constantly equal to the maximum power capacity without using any one of a battery and a condenser.

14. The power management system of claim 12, wherein the controllable secondary power source is a natural gas power plant.
